(19) United States
(12) Patent Application Publication
(10) Pub. No.: US 2007/0001332 A1
(43) Pub. Date: Jan. 4, 2007

(54) Injection molding machine and method

(75) Inventors: Yukkiang Lau, Chiba (JP); Katsumi Akita, Chiba (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, LTD

(21) Appl. No.: 10/572,758

(22) PCT Filed: Sep. 24, 2004
(86) PCT No.: PCT/JP04/13954

§ 371 Date: Mar. 21, 2006

(30) Foreign Application Priority Data
Oct. 2, 2003 (JP) 2003-344367

(51) Int. Cl. B29C 45/78

(52) U.S. Cl. 264/40.6; 264/328.1; 264/144; 425/550; 425/144

(57) ABSTRACT

An object is to provide an injection molding machine and an injection molding method which can prevent deterioration of injection characteristics and improve the quality of molded products. An injection molding machine includes a cylinder member; an injection member disposed in the cylinder member such that the injection member can advance and retreat; a plurality of heaters disposed on the outer circumference of the cylinder member; temperature detection sections disposed on the cylinder member at a plurality of positions along an axial direction so as to detect temperature of the cylinder member; a recording device (31) which stores a recorded target temperature distribution range indicating an optimal temperature range at each position of the cylinder member; and a control section for adjusting the set temperatures of the heaters such that each of the temperatures detected by means of the temperature detection sections falls within the target temperature distribution range. In this case, since the set temperatures of the heaters are adjusted such that the detected temperatures fall within the target temperature distribution range, the molding material within the cylinder member can be maintained in an optimal state.

### TECHNICAL FIELD

The present invention relates to an injection molding machine and an injection molding method.

### BACKGROUND ART

Conventionally, in an injection molding machine, resin heated and melted in a heating cylinder is injected under high pressure into a cavity of a mold apparatus so that the cavity is filled with the molten resin. The molten resin is then cooled and solidified within the cavity so as to obtain a molded product.

The injection molding apparatus includes a mold apparatus, a mold clamping apparatus, and an injection apparatus. The mold clamping apparatus includes a stationary platen and a movable platen, which is advanced and retreated by means of a drive section for mold clamping. Thus, mold closing, mold clamping, and mold opening operations of the mold apparatus are performed.

Meanwhile, the injection apparatus includes a heating cylinder for heating and melting resin, and an injection nozzle for injecting the molten resin. A screw is disposed within the heating cylinder such that the screw can rotate and can advance and retreat. When the screw is advanced by means of a drive unit disposed at the rear end, the resin is injected from the injection nozzle. When the screw is rotated by means of the drive unit, the molten resin is metered and accumulated forward of a screw head.

Incidentally, the screw has a supply portion which is supplied with resin dropped from a hopper, a compression portion in which the supplied resin is melted while being compressed, and a metering portion in which a predetermined amount of the molten resin is measured in a single operation. In the compression portion, the outer diameter of the body of the screw; i.e., the screw body, increases toward the front so as to reduce the clearance between the screw and the heating cylinder toward the front, whereby the resin is compressed (see, for example, Patent Document 1).

Moreover, a plurality of heaters are disposed on the outer circumferences of the heating cylinder and the injection nozzle, and a plurality of temperature sensors are disposed on the heating cylinder at predetermined positions so as to detect temperature of the heating cylinder. On the basis of the detected temperatures, the heaters are individually electrified so as to control the temperature of the heating cylinder at the predetermined positions such that the resin has different temperatures at the respective positions of the heating cylinder.

The heating cylinder is cooled by means of a water cooling cylinder provided at a supply port to which resin is supplied, so that the temperature of the heating cylinder is prevented from becoming excessively high. Therefore, the resin temperature is set to the lowest at the supply port, is increased from the supply port toward the front, and is maintained constant in a region forward of a predetermined position.
Patent Document 1: Japanese Patent Application Laid-Open (kokai) No. H11-227019.

### DISCLOSURE OF THE INVENTION

### Problems to be Solved by the Invention

However, in the conventional injection molding machine, when the amount of resin accumulated forward of the screw head through metering; i.e., the metering amount, is changed, the amount of heat required for melting resin in a single metering operation changes. Moreover, when the period or time length of the molding cycle is changed, the amount of heat to be supplied from each heater to resin per unit time changes.

In such cases, since difficulty is encountered in setting the temperature in the vicinity of the supply port to a proper value, a variation arises in the molten state of resin, and load acting on the screw changes, whereby injection characteristics deteriorate, and the quality of molded products deteriorates.

An object of the present invention is to solve the above-mentioned problems in the conventional injection molding machine and to provide an injection molding machine and an injection molding method which can prevent deterioration of injection characteristics and improve the quality of molded products.

### Means for Solving the Problems

To achieve the above object, an injection molding machine according to the present invention comprises a cylinder member; an injection member disposed in the cylinder member such that the injection member can advance and retreat; a plurality of heaters disposed on the outer circumference of the cylinder member; temperature detection sections disposed on the cylinder member at a plurality of positions along an axial direction thereof so as to detect temperature; a recording device which stores a recorded target temperature distribution range indicating an optimal temperature range at each position of the cylinder member; and a control section for adjusting set temperatures of the heaters such that each of the temperatures detected by means of the temperature detection sections falls within the target temperature distribution range.

### Effects of the Invention

The injection molding machine according to the present invention comprises a cylinder member; an injection member disposed in the cylinder member such that the injection member can advance and retreat; a plurality of heaters disposed on the outer circumference of the cylinder member; temperature detection sections disposed on the cylinder member at a plurality of positions along an axial direction thereof so as to detect temperature; a recording device which stores a recorded target temperature distribution range indicating an optimal temperature range at each position of the cylinder member; and a control section for adjusting set temperatures of the heaters such that each of the temperatures detected by means of the temperature detection sections falls within the target temperature distribution range.

In this case, since the set temperatures of the heaters are adjusted such that each of the detected temperatures falls within the target temperature distribution range, the amount of heat applied to a molding material can be controlled to fall within a proper range, and the molding material within the cylinder member can be maintained in an optimal state. Accordingly, it becomes possible to prevent generation of a variation in the molten state of the molding material and to maintain constant a load acting on the screw, to thereby improve the quality of molded products.

### BRIEF DESCRIPTION OF THE DRAWINGS

FIG. 1 is a block diagram showing a control circuit of an injection molding machine according to an embodiment of the present invention.

FIG. 2 is a schematic view of an injection apparatus according to the embodiment of the present invention.

FIG. 3 is a graph showing the temperature characteristic of the injection apparatus according to the embodiment of the present invention.

### DESCRIPTION OF REFERENCE NUMERALS

11: heating cylinder
12: screw
20: control section
31: recording device
h1 to h6: heaters
s1 to s5: heater temperature sensors
s6, s7: resin temperature sensors

### BEST MODE FOR CARRYING OUT THE INVENTION

An embodiment of the present invention will next be described in detail with reference to the drawings.

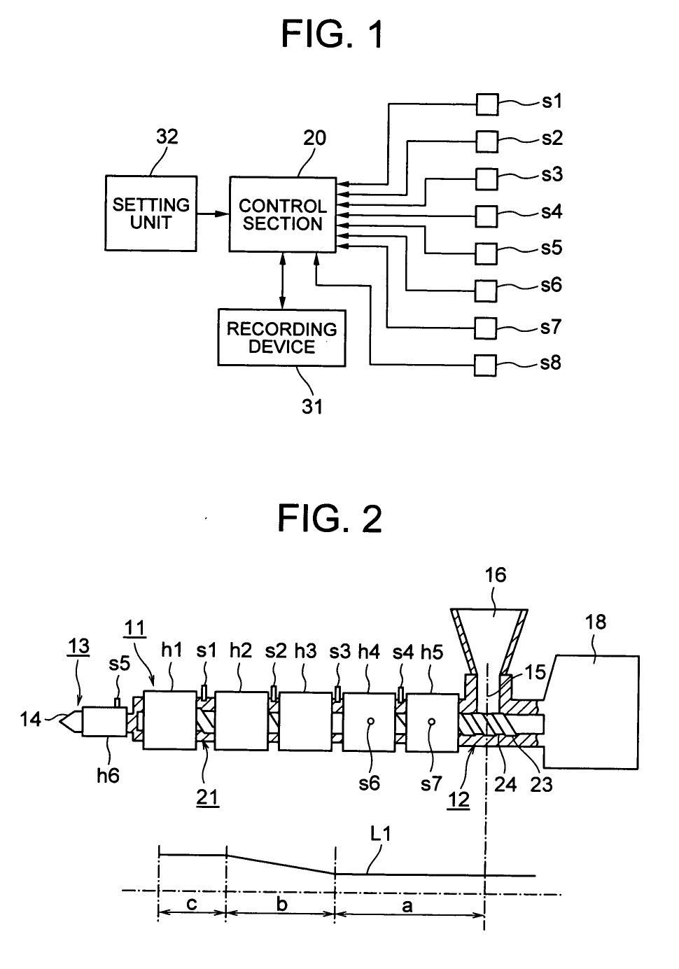

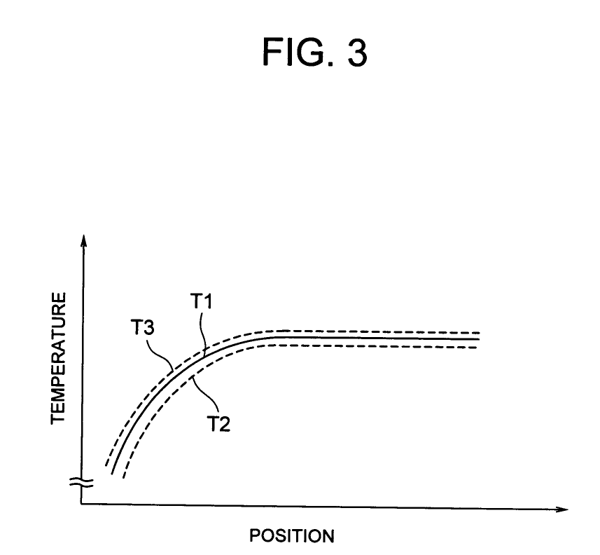

FIG. 1 is a block diagram showing a control circuit of an injection molding machine according to the embodiment of the present invention. FIG. 2 is a schematic view of an injection apparatus according to the embodiment of the present invention. FIG. 3 is a graph showing the temperature characteristic of the injection apparatus according to the embodiment of the present invention. In FIG. 3, the horizontal axis represents position, and the vertical axis represents temperature.

In these drawings, reference numeral 11 denotes a heating cylinder (cylinder member); 12 denotes a screw (injection member) disposed in the cylinder member 11 such that the screw member can rotate and can advance and retreat (move in the left-right direction in FIG. 2); 13 denotes an injection nozzle attached to a front end (left end in FIG. 2) of the heating cylinder 11; 14 denotes a nozzle opening formed in the injection nozzle 13; 15 denotes a supply port formed in the heating cylinder 11 at a predetermined position near its rear end (right end in FIG. 2) and adapted to supply unillustrated resin (molding material); and 16 denotes a hopper for storing the resin. A plurality of heaters h1 to h5 are disposed on the outer circumference of the heating cylinder 11 to be located adjacent to one another in the axial direction. A heater h6 is disposed on the outer circumference of the injection nozzle 13. The above-mentioned resin can be heated and melted through individual supply of electricity to the heaters h1 to h6.

Heater temperature sensors (first temperature detection sections or heater temperature detection sections) s1 to s5 are disposed at a plurality of predetermined positions along the axial direction of the heating cylinder 11; in the present embodiment, they are disposed such that the heater temperature sensor s1 is located between the heaters h1 and h2, the heater temperature sensor s2 is located between the heaters h2 and h3, the heater temperature sensor s3 is located between the heaters h3 and h4, the heater temperature sensor s4 is located between the heaters h4 and h5, and the heater temperature sensor s5 is located in the vicinity of the rear end of the heater h6. Moreover, resin temperature sensors (second temperature detection sections or molding-material temperature sensors) s6 and s7 are disposed on a plurality of heaters disposed in a predetermined region on the side toward the supply port 15; in the present embodiment, they are disposed on the two heaters h4 and h5.

The heater temperature sensors s1 to s5 detect the temperatures of the heating cylinder 11 and the injection nozzle 13 in the vicinity of the heaters h1 to h6, respectively. The resin temperature sensors s6 and s7 detect the temperature of the resin which is present within the heating cylinder 11 on the side toward the supply port 15. Signals indicative of the detected temperatures are fed to a control section 20. Unillustrated temperature control processing means of the control section 20 performs temperature control processing so as to control supply of electricity to the heaters h1 to h6 on the basis of the detected temperatures such that the temperatures of the resin coincide with the set temperatures.

Notably, if the temperature of the heating cylinder 11 at the supply port 15 is higher than the melting point of the resin, the resin supplied to a supply portion a is immediately melted, which makes metering difficult to perform smoothly. In view of this, an unillustrated water cooling cylinder, serving as a cooling apparatus, is disposed at the supply port 15. The water cooling cylinder cools the heating cylinder 11 by means of cooling water (cooling medium) so as to prevent the resin from being immediately melted.

In this case, as indicated by line T1 in FIG. 3, the resin temperature is set to the lowest at the supply port 15 (a left end portion of line T1 in FIG. 3), is increased from the supply port 15 toward the front (leftward in FIG. 2), and is maintained constant in a region forward of a predetermined position.

A drive unit 18 including a metering motor (drive section for metering), an injection motor (drive section for injection), etc. is disposed at the rear end of the screw 12.

The screw 12 includes a flight portion 21 and an unillustrated screw head attached to the front end of the flight portion 21. The flight portion 21 includes a flight 23 spirally formed on the outer circumferential surface of the screw body, whereby a spiral groove 24 is formed along the flight 23.

The screw 12 has, from the rear (right side in FIG. 2) toward the front, the above-mentioned supply portion a which is supplied with resin dropped from the hopper 16; a compression portion b in which the supplied resin is melted while being compressed; and a metering portion c in which a predetermined amount of the molten resin is measured in a single operation. The outer diameter of the bottom of the groove 24; i.e., the screw body, is set to be relatively small at the supply portion a, to gradually increase at the compression portion b from the rear to the front, and to be relatively large at the metering portion c. In FIG. 2, L1 represents the outer circumferential surface of the screw body.

Accordingly, the clearance between the inner circumferential surface of the heating cylinder 11 and the outer circumferential surface of the screw body is relatively large at the supply portion a, gradually decreases at the compression portion b from the rear to the front, and is relatively small at the metering portion c.

When the screw 12 is rotated in a regular direction through drive of the metering motor in a metering step, the resin within the hopper 16 is supplied to the supply portion a via the supply port 15, and is caused to advance (move leftward in FIG. 2) within the groove 24. With this, the screw 12 is caused to retreat (move rightward in FIG. 2), whereby the resin is accumulated forward of the screw head. Notably, the resin within the groove 24 assumes the form of pellets at the supply portion a, is half melted at the compression portion b, and is completely melted and becomes liquid at the metering portion c.

When the screw 12 is advanced through drive of the injection motor in an injection step, the resin accumulated forward of the screw head is injected from the injection nozzle 13, and is charged into the cavity of an unillustrated mold apparatus having undergone mold closing. At this time, the resin accumulated forward of the screw head may flow in the reverse direction. In order to present such reverse flow of the resin, a reverse-flow prevention device composed of a reverse-flow prevention ring and a seal ring, both not illustrated, is disposed around the screw head.

Meanwhile, when the metering amount is changed, the amount of heat required for melting resin in a single metering operation changes. Moreover, the period of the molding cycle is changed, and the amount of heat to be supplied from each of the heaters h1 to h6 to the resin per unit time changes.

That is, when the metering amount is increased, the amount of heat required to melt the resin increases. When the molding cycle is shortened, the amount of heat applied to the resin decreases. In these cases, as indicated by line T2, the actual temperature of the resin becomes lower than the set temperature. For example, in a case where the period of a molding cycle for molding a product of 100 g is changed from 10 sec to 8 sec, the amount of heat applied to the resin from the heaters h1 to h6 decreases by about 20%.

In contrast, when the metering amount is decreased, the amount of heat required to melt the resin decreases. When the molding cycle is made longer, the amount of heat applied to the resin increases. In these cases, as indicated by line T3, the actual temperature of the resin becomes higher than the set temperature.

As described above, when the metering amount is changed or when the molding cycle is changed, setting the resin temperature to a proper value becomes difficult. As a result, the load acting on the screw 12 changes, whereby injection characteristics deteriorate, and the quality of molded products deteriorates.

In order to overcome this drawback, in addition to the heater temperature sensors s3 and s4 for supply of electricity to the heaters h4 and h5, the above-mentioned resin temperature sensors s6 and s7, arranged along the axial direction of the heating cylinder 11, are disposed on a portion of the heating cylinder 11, which portion corresponds to the supply portion a of the screw 12 at the start of the metering step. The heater temperature sensors s3 and s4 are used so as to detect the temperatures of the heating cylinder 11 in the vicinity of the heaters h4 and h5, and the resin temperature sensors s6 and s7 are used so as to detect the temperature of the resin within the heating cylinder 11. Signals indicative of the detected temperatures are fed to the control section 20. The resin temperature sensors s6 and s7 are disposed in the heating cylinder 11 to be located in the vicinity of the inner circumferential surface thereof, to thereby enable detection of the resin temperature.

A reference temperature distribution curve which represents an optimal resin temperature range at each position of the heating cylinder 11 is calculated on the basis of past data; and a target temperature distribution range which represents an optimal temperature range at each position of the heating cylinder 11 is calculated on the basis of the reference temperature distribution curve. Data of the target temperature distribution range include each axial position of the heating cylinder 11, and upper limit and lower limit temperatures at each position. The target temperature distribution range is calculated in advance on the basis of the past data, and is recorded on a recording device 31. The target temperature distribution range can be changed through operation of a setting unit 32.

The heat generated by the heaters h1 to h6 requires a long time to be transmitted to the resin, and heat transfer, which is low in response, is involved. Therefore, performing precise feedback control is difficult. In view of this, the target temperature distribution range is set by use of upper limit and lower limit temperatures so as to impart a range to the target temperature. Accordingly, the target temperature distribution range can be readily changed.

Unillustrated temperature setting processing means of the control section 20 performs temperature setting processing so as to read the temperatures detected by the heater temperature sensors s1 to s5 and the resin temperature sensors s6 and s7; i.e., the detected temperatures, reads from the recording device 31 the upper limit and lower limit temperatures at each position, and determines whether the detected temperatures fall within the target temperature distribution range. When the detected temperatures do not fall within the target temperature distribution range, the temperature setting processing means adjusts the set temperature of the cooling water supplied to the water cooling cylinder and the set temperatures of the heaters h1 to h6.

For example, the actual temperature of the resin changes as a result of exchange of the resin used for molding, the heating cylinder 11, etc. Therefore, the temperature setting processing means adjusts the set temperature of the cooling water and the set temperatures of the heaters h1 to h6 such that the detected temperatures fall within the target temperature distribution range.

Further, when the resin used for molding, the heating cylinder 11, etc. is exchanged, an operator may change the metering program through operation of the setting unit 32 to thereby change the back pressure, etc. In such a case, the rotational speed of the screw 12 in the metering step changes, and consequently, the molten state of the resin changes. In view of this, even in the case where the metering program is changed, when the actual temperature of the resin changes, the temperature setting processing means adjusts the set temperature of the cooling water and the set temperatures of the heaters h1 to h6 such that the detected temperatures fall within the target temperature distribution range.

When molding conditions are set, the operator may change the molding cycle through operation of the setting unit 32. In such a case the temperature setting processing means compares the detected temperatures and the reference temperature distribution curve under the molding conditions before being changed, and adjusts the set temperature of the cooling water and the set temperatures of the heaters h1 to h6 on the basis of the comparison results.

Since the set temperature of the cooling water and the set temperatures of the heaters h1 to h6 are adjusted such that the detected temperatures fall within the target temperature distribution range, the resin within the heating cylinder 11 can be maintained in the optimal state. Accordingly, it becomes possible to prevent generation of variation in the molten state of the resin, render the load acting on the screw 12 constant, to thereby prevent deterioration of the injection characteristics. As a result, the quality of molded products can be improved.

Since the resin temperature sensors s6 and s7 are disposed in addition to the heater temperature sensors s1 to s5, the actual resin temperature can be detected by the resin temperature sensors s6 and s7, whereby a change in temperature can be quickly grasped. That is, when the metering amount is increased or the molding cycle is shortened, the required heat amount increases, and when the metering amount is decreased or the molding cycle is made longer, the required heat amount decreases. In these case, the actual amount of heat required to melt the resin greatly changes in particular in the vicinity of the supply port 15. However, since the actual resin temperature can be detected by the resin temperature sensors s6 and s7, a change in temperature can be quickly grasped. Accordingly, the set temperature of the cooling water and the set temperatures of the heaters h1 to h6 can be reliably adjusted.

Incidentally, since the heater temperature sensors s3 and s4 is lower in responsiveness than the resin temperature sensors s6 and s7, when the actual resin temperature changes, such a temperature change cannot be grasped quickly. Accordingly, for adjustment of the set temperatures of the heaters h4 and h5, the temperatures detected by the resin temperature sensors s6 and s7 are mainly used.

That is, when one of the temperatures detected by the resin temperature sensors s6 and s7 deviates from the target temperature distribution range, the temperature setting processing means calculates the difference between the detected temperature and the set temperature, and calculates the amount of heat required to reduce the temperature difference to zero by reading the required heat amount with reference to a heat amount table stored in the recording device 31. Subsequently, the temperature setting processing means reads a setting temperature corresponding to the heat amount with reference to a setting temperature table stored in the recording device 31, and adjusts the set temperatures of the heaters h4 and h5.

In the present embodiment, the heat amount is calculated on the basis of the difference between the detected temperature and the set temperature, and the set temperature is adjusted in accordance with the heat amount. However, the embodiment may be modified to perform feedback control on the basis of the temperature difference to thereby adjust the set temperature.

Incidentally, the actual resin temperature within the heating cylinder 11 changes depending on shear heat generated as a result of rotation, reciprocation, etc. of the screw 12. In view of this, a screw position sensor (position detection section) s8 is provided, and determination as to whether or not the metering amount has changed is performed on the basis of the position of the screw 12 detected by the screw position sensor s8. In such a case, when the screw position sensor s8 detects the position of the screw 12 and sends to the control section 20 a signal indicative of the position, unillustrated molding condition determination processing means of the control section 20 performs molding condition determination processing so as to read the position of the screw 12 and determines whether or not the metering amount has changed on the basis of the position. When the metering amount has changed, the temperature setting processing means compares the detected temperatures and the reference temperature distribution curve under the molding conditions before being changed, and adjusts the set temperature of the cooling water and the set temperatures of the heaters h1 to h6 on the basis of the comparison results.

Although the heat amount can be calculated on the basis of the heat capacity, specific heat, etc. of the heating cylinder 11, as described above, the actual resin temperature within the heating cylinder 11 changes due to shear heat generated as a result of rotation, reciprocation, etc. of the screw 12. In addition, the heat amount changes depending on the outer diameter, inner diameter, axial length, material, etc. of the water cooling cylinder, or changes in ambient temperature. Accordingly, the above-mentioned heat amount table is prepared in consideration of these variable factors. Notably, the heat amount can be calculated in accordance with a predetermined calculation formula without reading the heat amount with reference to the heat amount table.

In the present embodiment, the resin temperature sensors s6 and s7 are disposed in the vicinity of the supply port 15. However, the resin temperature sensors s6 and s7 may be disposed at an intermediate portion or a front end portion of the heating cylinder 11.

At the intermediate or front end portion of the heating cylinder 11, the resin receives heat from the heaters h1 to h5 and has a sufficiently high temperature. Therefore, the temperature of the resin hardly changes even if the amount of heat applied to the resin from the outside is changed when the metering amount is changed or the period of the molding cycle is changed. Accordingly, if the resin temperature sensors are disposed at the intermediate or front end portion of the heating cylinder 11 so as to detect the actual resin temperature at the intermediate or front end portion, a change in temperature cannot be grasped sufficiently quickly. Therefore, the resin temperature sensors s6 and s7 are preferably disposed in the vicinity of the supply port 15 as in the present embodiment.

In the case where the actual resin temperature does not fall within the target temperature distribution range even after adjustment of the set temperature of the cooling water and the set temperatures of the heaters h1 to h6 by the temperature setting processing means, unillustrated anomaly detection processing means of the control section 20 performs anomaly detection processing so as to issue a warning or make the molding cycle longer. Further, in the case where the calculated heat amount exceeds the range in which the set temperatures of the heaters h4 and h5 are adjusted, the anomaly detection processing means performs the anomaly detection processing.

In the present embodiment, the set temperature of the cooling water and the set temperatures of the heaters h1 to h6 are adjusted by the temperature setting processing means. However, an operator may adjust the set temperature of the cooling water and the set temperatures of the heaters h1 to h6 by operating the setting unit 32.

In the present embodiment, the temperature setting processing means adjusts the set temperature of the cooling water together with the set temperatures of the heaters h1 to h6. However, the temperature setting processing means may adjust the set temperatures of the heaters h1 to h6 only.

The present invention is not limited to the above-described embodiment. Numerous modifications and variations of the present invention are possible in light of the spirit of the present invention, and they are not excluded from the scope of the present invention.

### INDUSTRIAL APPLICABILITY

The present invention can be applied to injection molding machines.

1. An injection molding machine comprising:
(a) a cylinder member;
(b) an injection member disposed in the cylinder member such that the injection member can advance and retreat;
(c) a plurality of heaters disposed on the outer circumference of the cylinder member;
(d) temperature detection sections disposed on the cylinder member at a plurality of positions along an axial direction thereof so as to detect temperature;
(e) a recording device which stores a recorded target temperature distribution range indicating an optimal temperature range at each position of the cylinder member; and
(f) a control section for adjusting set temperatures of the heaters such that each of the temperatures detected by means of the temperature detection sections falls within the target temperature distribution range.

2. An injection molding machine according to claim 1, further comprising:
(a) a cooling apparatus disposed at a supply port of the cylinder member to which a molding material is supplied and adapted to cool the cylinder member, wherein
(b) the control section adjusts a set temperature of a cooling medium of the cooling apparatus such that the temperatures detected by the temperature detection sections fall within the target temperature distribution range.

3. An injection molding machine according to claim 1, wherein the temperature detection sections include a plurality of heater temperature sensors disposed in the vicinity of the respective heaters, and a molding-material temperature sensor disposed on a side toward a supply port of the cylinder member to which a molding material is supplied.

4. An injection molding machine according to claim 1, wherein the control section adjusts the set temperatures of the respective heaters on the basis of mainly the temperature detected by the molding-material temperature sensor.

5. An injection molding machine according to claim 4, wherein the control section calculates a required heat amount on the basis of a difference between the temperature detected by the molding-material temperature sensor and each target temperature of the target temperature distribution range recorded on the recording device, and adjusts the set temperatures of the respective heaters in accordance with the calculated heat amount.

6. An injection molding method comprising the steps of:
(a) detecting temperature of a cylinder member by use of temperature detection sections disposed on the cylinder member at a plurality of positions along an axial direction thereof,
(b) reading from a recording device a target temperature distribution range indicating an optimal temperature range at each position of the cylinder member; and
(c) adjusting set temperatures of a plurality of heaters disposed on the outer circumference of the cylinder member such that each of the temperatures detected by means of the temperature detection sections falls within the target temperature distribution range.

7. An injection molding method according to claim 6, wherein the temperature of the cylinder member is detected by a plurality of heater temperature sensors disposed in the vicinity of the respective heaters, and a molding-material temperature sensor disposed on a side toward a supply port of the cylinder member to which a molding material is supplied.

8. An injection molding method according to claim 7, wherein the set temperatures of the respective heaters are adjusted on the basis of mainly the temperature detected by the molding-material temperature sensor.
